(19) United States
(12) Patent Application Publication
(10) Pub. No.: US 2022/0282899 A1
(43) Pub. Date: Sep. 8, 2022

(54) SEQUENTIAL COOLING TUNNEL AND METHOD OF USE

(71) Applicant: GOLDEN PRODUCE I.P. PTY LTD, Hawthom East, Victoria (AU)

(72) Inventor: Michael Panuccio, Mildura, Victoria (AU)

(21) Appl. No.: 17/637,788

(22) PCT Filed: Aug. 24, 2020
(86) PCT No.: PCT/AU2020/050887

§ 371 Date: Feb. 23, 2022

(30) Foreign Application Priority Data
Aug. 23, 2019 (AU) 2019219837

(51) Int. Cl. F25D 13/06; F25D 13/04; A23L 3/36; A23L 3/00

(52) U.S. Cl. CPC F25D 13/067; F25D 13/04; A23L 3/361; A23L 3/001; F25D 2400/28; A23V 2002/00

(57) ABSTRACT

The invention is a cooling tunnel for rapidly cooling a food product (1). The cooling tunnel (10) includes a plurality of thermal zones (21, 31) within the tunnel, and a conveying means (14) for transporting the food product sequentially therethrough. In operation, circulating air and the food product within each thermal zone are in a heat exchange relationship whereby heat from the food product is transferred to the circulating air and a heat exchanger extracts heat from the circulating air and exhausts the heat from the thermal zone.

### TECHNICAL FIELD

This invention relates to a cooling tunnel comprising a plurality of thermal zones, and a method of using the tunnel to rapidly cool food products passing sequentially therethrough.

### BACKGROUND

Many observable physical and chemical changes in food products are brought about by the way their temperature and moisture content are regulated. For example, the appearance, taste and smell of fresh food products, including fruit and vegetables and meats, can be affected by the temperatures at which such products are stored.

Fresh fruit and vegetables, commonly referred to as fresh produce, are typically grown on large commercial farms. The agricultural lands on which these farms are situated are often located in rural areas far away from homes, with most consumers purchasing their fresh produce from local supermarkets in their immediate vicinity. As such, many days or in some cases weeks can pass between the produce being initially harvested/picked at the farms and orchards, and it being made available to consumers on supermarket shelves.

As soon as fresh produce is harvested, it begins to deteriorate or degrade, primarily through loss of moisture, which often results in the produce being unacceptable for sale to the end consumer at some later date. The rate of spoilage of fresh produce is temperature dependent; the longer the fresh produce is exposed to high ambient temperatures after harvesting, the greater the extent of deterioration. However, the extent of the deterioration is often not known until the produce is retrieved from storage at supermarkets or is bought by consumers, much to their disappointment and annoyance.

For at least these reasons, different apparatus and methods for rapidly and effectively cooling food products have been developed.

These methods include the use of conventional refrigeration, flash freezing, forced air cooling and the like. However, whilst these methods can rapidly cool fresh produce to a degree, there are a number of associated problems.

One of the problems is the time it takes to cool the fresh produce, for example, and the space needed to store the cooling fruit. Even using forced air for cooling the environment or atmosphere, it can take more than 24 hours to cool fruit and vegetables from high ambient temperatures to temperatures that allow transportation of the produce to markets. Therefore, the area required within which to locate the produce whilst it is being cooled to a low temperature over the up to 24-hour period is extremely high, particularly during intensive harvest seasons in which there is a high yield of produce, most of which requires cooling simultaneously.

Another problem associated with forced air cooling is the unevenness of cooling achieved. As air is blown over and around containers of produce within a cooling installation, the cooling air contacts the top and sides of the container only, resulting in uneven cooling of the produce contained within the container. In many instances, the top layer or layers of produce located in the open top containers is cooled excessively, whilst fruit contained within the interior or in the bulk of the container is cooled inadequately. Furthermore, in storage the heat from the relatively warmer produce located internally within the container is radiated to the relatively cooler produce around the edges which results in the produce being on average at a warmer temperature for a longer time than is desirable thereby further promoting spoilage and a short storage life.

In the same way, regulation of the temperature of freshly slaughtered animal carcasses can affect the flavour and tenderness of the meat products formed.

The quality and tenderness of meat is associated with the length of muscle fibres within the carcass. Muscle fibres are shorter in contracted muscles and longer in relaxed muscles. If contracted muscles are cooked they tend to be tough, while relaxed muscles tend to be tender. The biological process of rigor mortis within a carcass is important because it fixes the lengths of the muscle fibres and therefore the potential texture of the meat. Muscles entering rigor in a contracted state will tend to produce tough meat; those entering rigor in a relaxed, or stretched, state will produce tender meat. This is taken advantage of in certain methods of hanging carcasses, where certain muscles are stretched before they go into rigor, so that the sarcomeres are extended. The longer muscle length is ‘fixed’ when rigor develops so that the resulting meat is more tender.

Typically, as soon as an animal has been harvested and skinned in and abattoir, it is hung in cold storage to reduce loss and prevent the meat from spoiling by inhibiting bacterial growth. This process is not without its problems. If a carcass is exposed to too cold a temperature, and cooled too quickly, the cool temperature can act as a stimulus for the muscle fibres to contract, through a phenomenon known as cold shortening. Existing industry cooling methods commonly result in cold shortening occurring before the carcass undergoes the process of rigor mortis, resulting in a tougher meat. This problem is especially evident in smaller meat stock such as lamb, because their carcasses are small and so cool quickly.

The present invention was conceived with these problems in mind.

### SUMMARY

The invention provides a cooling tunnel for rapidly cooling a food product comprising a housing having an inlet at one end and an outlet at the other end, a conveying means for transporting the food product through the tunnel from the inlet to the outlet; the housing including a first cooling unit that defines a first thermal zone configured to cool the food product to a first temperature and a second cooling unit that defines a second thermal zone downstream of the first thermal zone in a direction of movement of the food product through the tunnel configured to cool the food product to a second temperature lower than the first temperature; each cooling unit including (a) an air circulation system for circulating air within the thermal zone, and (b) a heat exchanger for cooling air within the thermal zone; wherein in use the circulating air and the food product within each thermal zone are in a heat exchange relationship whereby heat from the food product is transferred to the circulating air and the heat exchanger extracts heat from the circulating air and exhausts the heat from the thermal zone.

In some embodiments, the first and second thermal zones may be thermally isolated from each other.

For example, the first and second thermal zones may be selectively sealable to restrict or prevent altogether air flow between thermal zones.

Each thermal zone may include at least two air chambers in fluid communication with each other.

In some embodiments, the cooling tunnel may further comprise one or more than one cooling units in addition to the first and second cooling units.

The air circulation system may include a plurality of fans.

The air circulation system may be configured to force air within each thermal zone to flow between the air chambers of the thermal zone.

The air circulation system may be configured so that air flow within each thermal zone is generally cyclonic.

The air circulation system may be configured so that air flow within each air chamber is generally vertical.

The air circulation system may include an air plenum located above the housing of the cooling tunnel to provide the fluid communication between the air chambers within each thermal zone.

The operating conditions, such as the time that the food product is within the first thermal zone and the temperature within the first thermal zone, may be selected so that, in use, the internal temperature of the food product drops from an initial temperature to the first temperature, where the first temperature is approximately 40-60%, typically half of the initial temperature.

The cooling tunnel may include more than two successive cooling units having thermal zones with air circulation systems and heat exchangers.

The invention also provides a method of cooling a food product in a cooling tunnel, the method including: (i) transporting the food product via a conveying means through an inlet of the cooling tunnel into a first thermal zone; (ii) supplying cooled air to the first thermal zone and thermally treating the food product within the first thermal zone for a time sufficient to lower the temperature of the food product from an initial temperature to a first temperature less than the initial temperature; (iii) transporting the food product via the conveying means from the first thermal zone into a second thermal zone; (iv) supplying cooled air to the second thermal zone and thermally treating the food product within the second thermal zone for a time sufficient to lower the temperature of the food product from the first temperature to a second temperature less than the first temperature; and (v) transporting the food product via the conveying means through an outlet of the cooling tunnel.

In some embodiments, thermally treating the food product may include exposing the food product to a forced air flow such that heat is transferred from the food product to air within the thermal zone.

In some embodiments a heat exchanger may transfer heat from the air within the thermal zone to ambient air outside of the tunnel.

The conveying means may be configured to periodically automatically advance the food product sequentially between the thermal zones.

In some embodiments, a further step of pre-cooling the food product from an ambient temperature to the initial temperature may precede step (i).

A further step of cooling the food product from the second temperature to a lower final temperature may follow step (v).

The method may include selecting the operating conditions, such as the time that the food product is within the first thermal zone and the temperature within the first thermal zone, so that the internal temperature of the food product drops from an initial temperature to the first temperature, where the first temperature is approximately half of the initial temperature.

The method may include transporting the food product via the conveying means through more than two successive cooling units having thermal zones and supplying cooled air and treating the food product in each thermal zone.

It is noted that the term “tunnel” as used herein covers any suitable structure that defines the multiple successive cooling units and thermal zones and has an inlet at one end and an outlet at the other end of the structure.

### BRIEF DESCRIPTION OF DRAWINGS

Embodiments of the invention will now be described in further detail below, wherein like reference numerals indicate similar parts throughout the several views. Embodiments are illustrated by way of example, and not by way of limitation, with reference to the accompanying drawings, in which:

FIG. 1 is a side schematic representation of a cooling tunnel for cooling a food product according to one embodiment of the invention having two thermal units and a conveying means for transporting the food product through the tunnel from an inlet to an outlet;

FIG. 2 is a side schematic representation of the cooling tunnel of FIG. 1 showing heat transfer relationships in the cooling tunnel as the food product is conveyed through the cooling tunnel;

FIG. 3 is side schematic representation of a cooling tunnel for cooling a food product according to another, although not the only other, embodiment of the invention having an air circulation system providing a cyclonic air flow;

FIG. 4 is side schematic representation of a cooling tunnel for cooling a food product according to another, although not the only other, embodiment of the invention having an air circulation system providing a vertical air flow;

FIG. 5 is a side schematic representation of the cooling tunnel of FIG. 3 with additional cooling units;

FIG. 6 is a side schematic representation of the cooling tunnel of FIG. 4 with additional cooling chambers; and

FIG. 7 is a side schematic representation of a cooling tunnel for cooling a food product according to another, although not the only other, embodiment of the invention which includes an air circulation system providing both a cyclonic and a vertical flow.

### DETAILED DESCRIPTION

In the following detailed description, reference is made to accompanying drawings which form a part of the detailed description. It will be readily understood that the aspects of the present disclosure, as generally described herein and illustrated in the drawings may be arranged, substituted, combined, separated and designed in a wide variety of different configurations, all of which are contemplated in this disclosure.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the example methods and materials are described herein.

In general terms, cooling tunnel 10 shown in the Figures provides a means of thermally treating a food product 1 as it is transported through the cooling tunnel 10. In use of the cooling tunnel 10, the food product 1 is cooled in such a manner that the cooling is energy efficient, rapid and controlled, obviating the need to store the food product for relatively long periods in order to cool the packed produce to a suitable temperature for transporting to consumers.

As is described in more detail below, the cooling tunnel 10 of each of the embodiments includes a first cooling unit 20 and a separate second cooling unit 30, defining distinct thermal treatment zones (first thermal zone 21 and second thermal zone 31). Each thermal zone is thermally isolated from each other. This arrangement is an important feature of the embodiments. Each cooling unit includes an air circulation system 15 (such as fans or other devices to propel and circulate air within the thermal zone) and a heat exchanger 16 for cooling the air within the thermal zone. A conveying means 14 transports the food product 1 through the tunnel 10, such that heat from the food product 1 is transferred to the air circulating within each thermal zone, the respective heat exchangers 16 extracting the heat from the air circulating within the respective thermal zones 21, 31, and exhausting it out of the cooling tunnel 10.

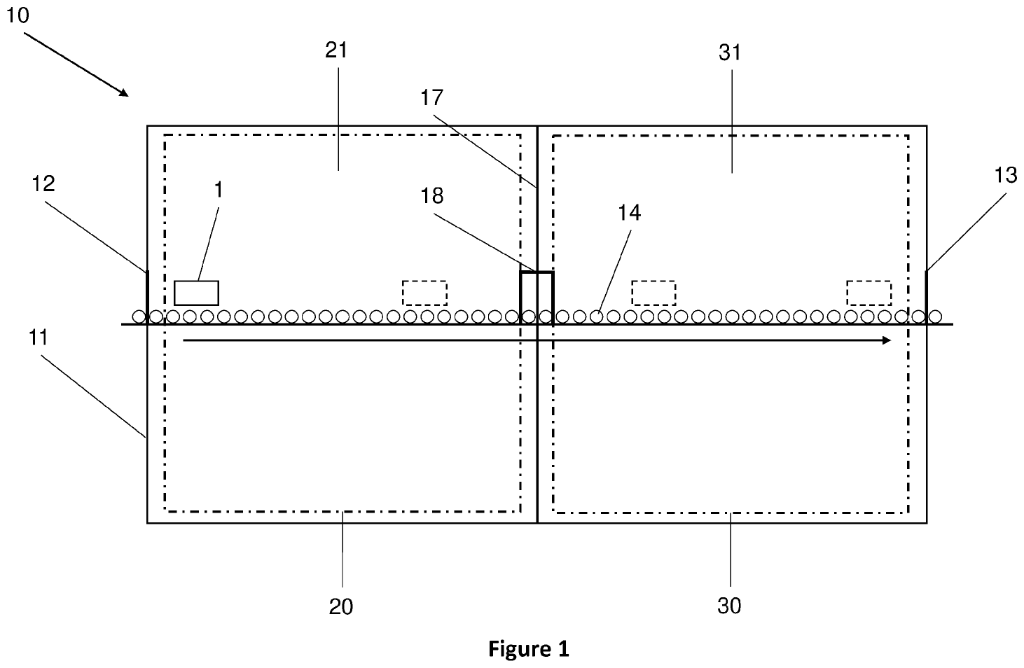

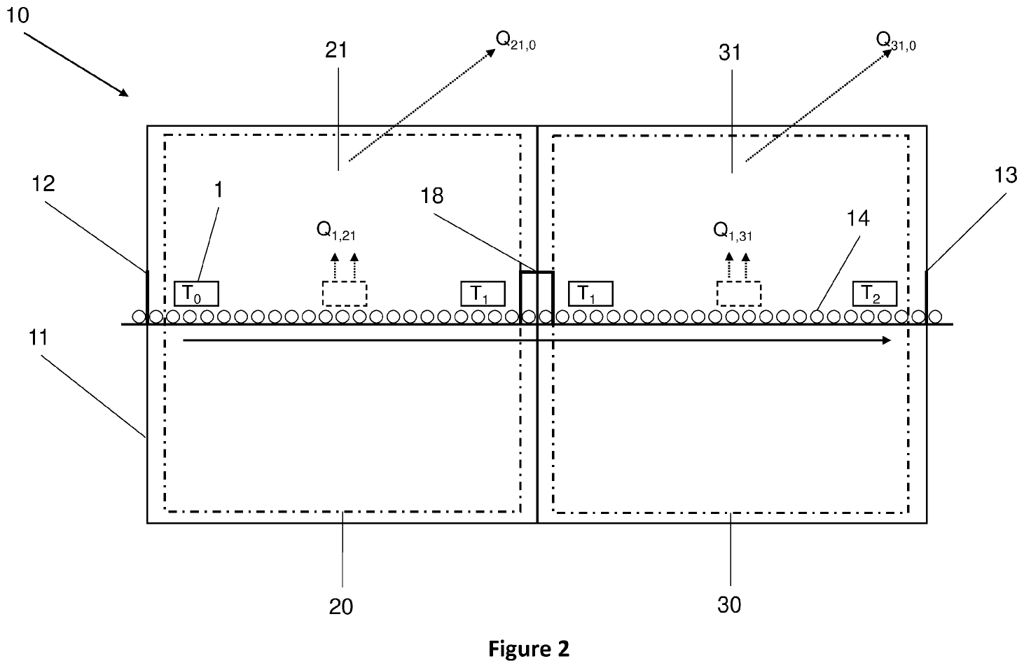

With reference to FIGS. 1 and 2, the cooling units 20, 30 are contained within a housing 11 of the cooling tunnel 10. The housing 11 may be any suitable structure. The housing has an inlet 12, located at a first end of the cooling tunnel 10, and an outlet 13, located at a second end of the cooling tunnel. Conveying means 14 extend from the inlet 12 to the outlet 13 of the cooling tunnel 10 for conveying the food product 1 from the inlet 12 to the outlet 13. The conveying means 14 may be any suitable conveying means. As illustrated, the conveying means 14 takes the form of a rolling conveyor. The conveying means 14 transports the cooling product 1 from the inlet 12 into the first cooling unit 20 and the second cooling unit 30, and through the outlet 13. A direction of movement of the food produce 1 within the cooling tunnel 10 is indicated by the arrow of FIG. 1.

Barrier 17 divides the housing 10 into the separate cooling units 20, 30. As illustrated, gate 18 is disposed on barrier 17 to provide passage for the food product 1 to pass sequentially from the first cooling unit 20 into the second cooling unit 30.

As depicted in the Figures, the cooling tunnel 10 is divided into two separate cooling units 20, 30. It is understood, however, that additional barriers 17, located at spaced apart locations within the housing 10, can divide the housing further, such that cooling tunnel 10 can comprise of additional thermally-isolated cooling units. For example, cooling tunnel 10 can comprise 3, 4, 5 or 6 or more separate thermally-isolated cooling units.

The barriers 17 can be fixed barriers, adjustable barriers, or movable barriers. Such embodiments are shown and described in more detail in relation to FIGS. 5, 6 and 7.

Each cooling unit 20, 30 defines a thermal treatment zone 21, 31. Air circulation systems 15 (not shown), typically in the form of fans, within each cooling unit 20, 30 promote the circulation of an airflow within each thermal treatment zone 21, 31. Heat exchangers 16 (not shown in FIGS. 1 and 2) provide a source of chilled air within each thermal treatment zone 21, 31. The temperature of air within the thermal treatment zones 21, 31 is less than an ambient temperature outside of the tunnel 10. Air circulation systems 15 and heat exchangers 16 regulate the conditions within the thermal zones 21, 31. Chilled air is controlled to predetermined temperature and provided at a predetermined rate to each separate thermally-isolated treatment zone 21, 31. The temperature of the air within each treatment zone 21, 31 need not be the same. However, in practice it is preferable for the temperature of the air within the second treatment zone 31 to be at least as cool as the temperature of air within the first treatment zone 21. Other variables are also controlled to predetermined values, such as relative humidity, pressure, velocity and the like.

Referring now particularly to FIG. 2, in operational use, the food product 1 is placed onto the conveying means 14 and transported through the inlet 12 into the first thermal zone 21. The conveying means 14 moves intermittently (but may move continuously). When the food product 1 is within the first thermal zone 21, the conveying means 14 stops for a predetermined or calculated period of time. The conveying means 14 then restarts to transport the food product 1 into the second thermal zone 31, prior to moving the food product 1 out of the tunnel 10 through outlet 13. Typically, the cooling process from inlet to outlet takes up to 2 hours, preferably up to 1 hour.

Upon entering the first thermal zone 21, the food product has an internal temperature of T₀. The temperature T₀ can be equivalent to an ambient temperature outside of the tunnel, or, alternatively, can be a pre-cooled temperature wherein the food product 1 is subject to a pre-cooling process prior to the entering the cooling tunnel 10. The pre-cooling process can include being stored in a refrigerated volume such as a cool-room or refrigerated vehicle.

Within the first thermal zone 21, the air circulation system 15 (not shown in FIGS. 1 and 2) forces the chilled air within the thermal zone to flow past the food product 1. The air circulation system 15 can take the form of one or more fans or any other suitable air circulation system. The circulating air and the food product 1 are in a heat exchange relationship, whereby heat from the food product 1 is transferred to the circulating air within the zone through forced convection. This heat transfer is indicated by the arrows Q_{1,21}. As such, the temperature of the food product 1 reduces. The air within the first thermal zone 21 is in fluid communication with the heat exchanger 16, such that the heat exchanger 16 extracts heat from the air, rejecting it to the ambient air outside of the tunnel 10. This heat transfer is indicated by the arrows Q_{21,0}. Air circulation means 15 includes a return system (not shown in FIGS. 1 and 2), such that the temperature of the air within the first thermal zone 21 remains chilled, compared to that of the ambient air outside of the tunnel.

The time that the food product 1 is held within the first thermal zone 21 is preferably calculated to be the required time for the internal temperature of the food product 1 to drop from the initial temperature T₀ to a temperature T₁, where T₁ is approximately half of the initial temperature T₀. After this time, the conveyor restarts, and the food product 1 is moved through gate 18 into the second thermal zone 31.

Within the second thermal zone 31, the air circulation system 15 (not shown) forces the chilled air within the thermal zone 31 to flow past the food product 1. The circulating air and the food product 1 are in a heat exchange relationship, whereby heat from the food product 1 is transferred to the circulating air within the zone through forced convection. This heat transfer is indicated by the arrows Q_{1,31}. As such, the temperature of the food product 1 reduces. The air within the second thermal zone 31 is in fluid communication with the heat exchanger 16, such that the heat exchanger 16 extracts heat from the air, rejecting it to the ambient air outside of the tunnel 10. This heat transfer is indicated by the arrows Q_{31,0}. Air circulation means 15 includes a return system (not shown in FIGS. 1 and 2), such that the temperature of the air within the second thermal zone 31 remains chilled, compared to that of the ambient air outside of the tunnel.

To enable multiple groups of food product to be processed through the tunnel 10 at the same time, the time period that food product 1 is held within the second thermal zone 31 is the same as the time period which the food product 1 was held within the first thermal zone. As such, it is to be noted that the thermal conditions within the second thermal zone 31 can be the same or different to the thermal conditions within the first thermal zone 21, depending on the desired temperature drop required. After this time expires, the conveyor restarts, and the food product 1 is moved through out of the second thermal zone 31.

As illustrated in the Figures, after moving out of the second thermal zone 31 the food product 1 exits the cooling tunnel 10 via the outlet 13, where it can then be transferred into a secondary storage medium, for longer term storage or transport. The secondary storage medium (not shown) can be a refrigerated truck or cool room. It is understood, however, that in the event that the tunnel 10 comprises additional cooling units, upon existing the second thermal zone the food product would pass through another gate 18 into the next sequential thermal zone and so on.

Multiple groups of food products 1 can be processed through the tunnel 10 at the same time, such that when a first group of food products is transported from the first thermal zone into the second thermal zone, a second group of food products is moved through the inlet 12 into the first thermal zone and so on.

As an illustrative example, a food product 1 such as fresh produce, arriving at the inlet 12 of the tunnel 10 at an initial temperature (T0) of about 16° C. or so are cooled to about 8° C. (T1) in the first thermal zone 21. The temperature and flow rate of the air is adjusted accordingly to achieve this temperature drop. When the temperature of the food product 1 within the first thermal zone 21 reaches on average the predetermined half initial temperature, the conveyor 14 operates automatically to transfer all of the food product 1 into the second thermal zone 31, whereupon cooling is applied to reduce the temperature further.

The conveying means 14 has a width approximately equal to the width of the housing 11, such that there is little to no air gap between sides of the conveyor 14 and the housing 11. Preferably, food product 1 is placed into containers 2 (not shown) prior to being placed onto the conveyor 14. Containers 2 having an approximate width equal to that of the conveyor 14. Containers 2 are provided with a ventilation means 3 (not shown) which allows passage of air through the containers 2. The ventilation means 3 can include one or more slots, apertures, perforations or openings allowing air to pass therethrough for circulation and/or recirculation through the containers 2. The openings are provided in the side surface of the container, or in the base surface, or in both. The ventilation means 2 allow cooling air to pass each individual food product 1 within the container 2 so that each individual item or member is subjected to substantially the same cooling environment. As such, air flow through the food product, and hence heat exchange, is maximised. Typically, the container is a box, preferably a box made from plastics material, such as polystyrene, styrofoam or the like, or from cardboard or a recycled material, including synthetic and natural materials.

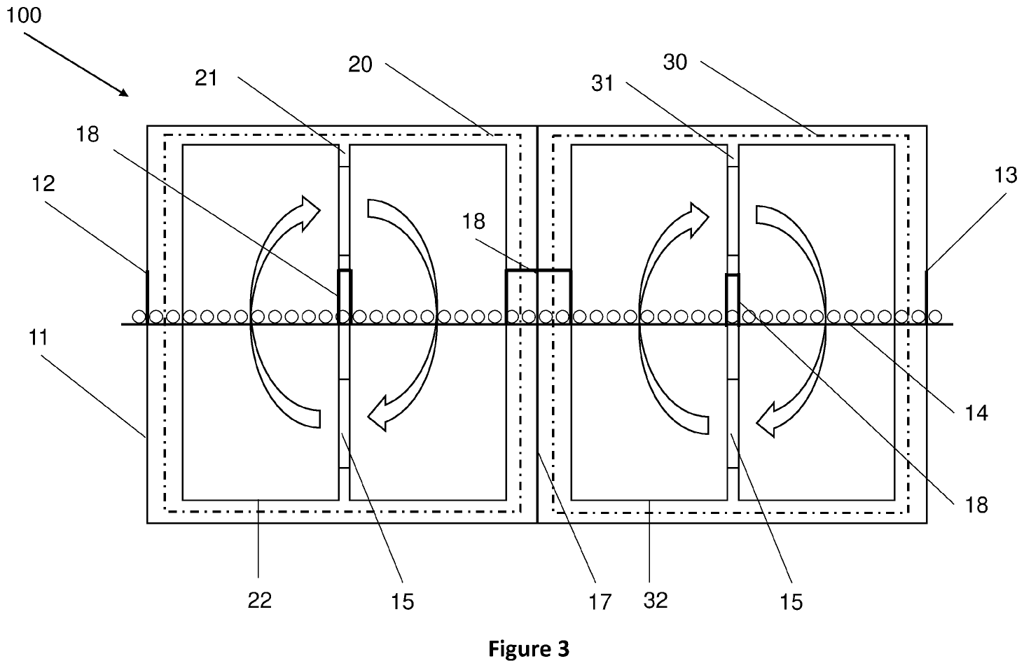

FIG. 3 shows an embodiment of a cooling tunnel 100, where the thermal zones 21, 31 include thermal chambers 22, 32 respectively. As illustrated, the thermal zones each include two thermal chambers, but this can be more. Thermal chambers 22 within the first thermal zone 21 are in fluid communication with each other. Thermal chambers 32 within the second thermal zone 32 are in fluid communication with each other. Additional gates 18 provide passage for food product 1 to travel between the chambers 22, 33 within each thermal zone 21, 31. The configuration of the thermal chambers 22, 32 and the air circulation means 15 provide a generally cyclonic air flow within the first and second thermal zones 21, 31, as indicated by the arrows in the Figure.

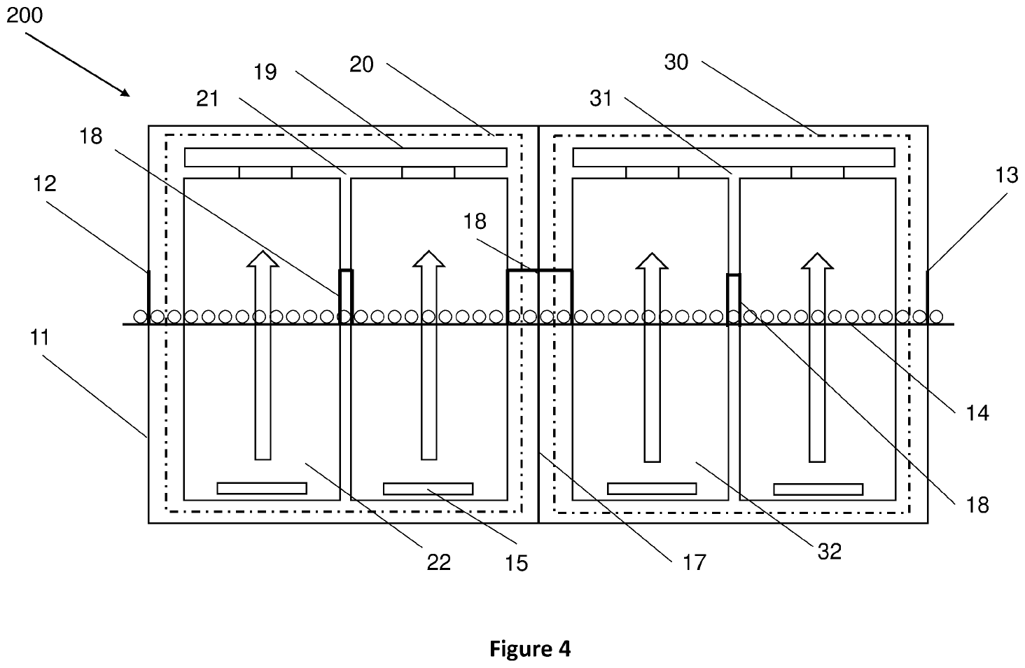

FIG. 4 shows an embodiment of a cooling tunnel 200, where thermal chambers 22 within the first thermal zone 21 are in fluid communication with each other via an air plenum. Thermal chambers 32 within the second thermal zone 32 are in fluid communication with each other via an air plenum 19. The configuration of the thermal chambers 22, 32 and the air circulation means 15 provide a generally vertical air flow within the first and second thermal zones 21, 31, as indicated by the arrows in the Figure.

It is understood that many other embodiments and arrangements of the cooling tunnel 10 are contemplated.

For example, cooling tunnel 100 can comprise further cooling units, in addition to the first 20 and second 30 cooling units described and show in in FIG. 3. Such an embodiment is illustrated schematically in FIG. 5, with the cooling tunnel having three cooling units. As shown, in operation, there is minimal or no airflow between cooling units. This arrangement enables finer control of the cooling process, through the increased number of step changes in temperature that are provided.

Further, FIG. 6 illustrates an embodiment of cooling tunnel 200, in which each thermal unit 21, 31 is divided into three air chambers 22, 32 respectively. Increasing the number of air chambers and minimising contamination or mixing of air flow therebetween can increase the rate of cooling and reduce the cooling capacity required within each cooling unit.

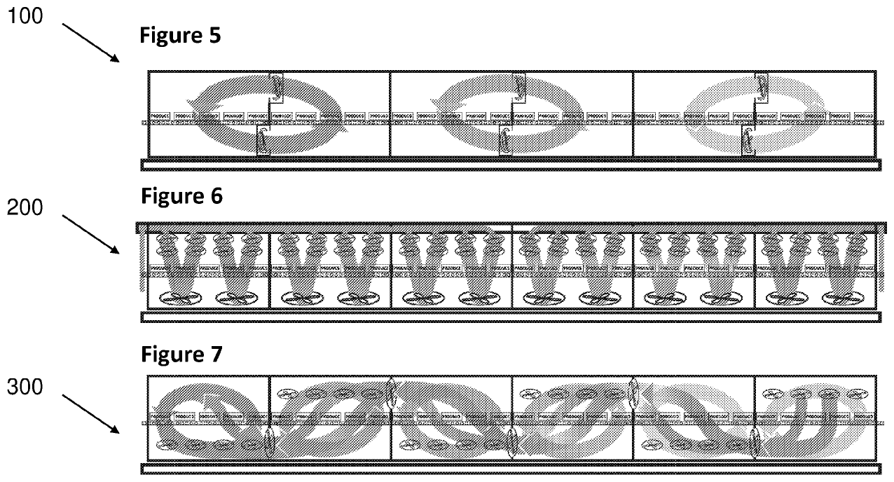

Additionally, FIG. 7 illustrates a further embodiment of a cooling tunnel 300, in which the air circulation system 15 is arranged to promote both a vertical and cyclonic flow, further encouraging rapid heat transfer from the food product 1 to the circulating air within the various thermal zones.

By way of summary, it is to be understood that the internal arrangements of the cooling tunnel 10 provide a cooling tunnel that is compartmentalized, segregated or sectioned into thermally isolated zones 21, 31, preferably with adjustable movable barriers 17 between adjacent cells, to provide different areas for cooling the food product 1 to different predetermined temperatures, preferably in sequence or in a prearranged order, in order to prolong the storage of food product 1 before the onset of spoilage or deterioration.

The many embodiments of the cooling tunnel 10, 100, 200, 300 provides advantages and cost savings over existing equipment and methods use to cool food product.

For example, the discrete thermal zones 21, 31 provide a rapid method of cooling the food product 1. The rate and degree of cooling is dependent on the temperature of air within the thermal zones, the duration of time for which the food products 1 are held within each zone, and the type and nature of food product being cooled. The cooling tunnel 10 can cool a food product such as punnets of grapes from an initial pulp temperature of 35° C. to approximately 1 degrees in less than an hour. Similarly, the cooling tunnel 10 can cool a 2 kg container of pasta sauce from an initial temperature of 100° C. to approximately 1 degrees in less than an hour. Further, the cooling tunnel 10 can cool corn cobs within husks from an initial temperature of 40° C. to approximately 1 degrees in less than an hour. Because of this rapid cooling rate, there is no need to provide large capacity storage shelves or racking for pre-storing food product 1 that requires cooling.

It is to be understood that, if any prior art publication is referred to herein, such reference does not constitute an admission that the publication forms a part of the common general knowledge in the art, in Australia or any other country.

In the claims which follow and in the preceding description of the disclosure, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the disclosure.

### LEGEND

| | |
|---|---|
| 1 | Food Product |
| 2 | Containers |
| 3 | Ventilation Means in Container |
| 10 | Cooling Tunnel |
| 11 | Housing |
| 12 | Inlet |
| 13 | Outlet |
| 14 | Conveying Means |
| 15 | Air Circulation System |
| 16 | Heat Exchanger |
| 17 | Barrier |
| 18 | Gate |
| 19 | Air Plenum |
| 20 | First Cooling Unit |
| 21 | First Thermal Zone |
| 22 | Air Chamber within First Thermal Zone |
| 30 | Second Cooling Unit |
| 31 | Second Thermal Zone |
| 32 | Air Chamber within Second Thermal Zone |
| 100 | Cooling Tunnel |
| 200 | Cooling Tunnel |
| 300 | Cooling Tunnel |
| T₀ | Temperature of food product entering first thermal zone |
| T₁ | Temperature of food product leaving first thermal zone |
| T₂ | Temperature of food product leaving second thermal zone |
| Q_{21, 0} | Heat Transfer from Cooling Unit to Ambient |
| Q_{1, 21} | Heat Transfer from Food Product to air within first thermal |
| | zone |
| Q_{1, 31} | Heat Transfer from Food Product to air within second thermal |
| | zone |

1. A cooling tunnel for rapidly cooling a food product comprising a housing having an inlet at one end and an outlet at the other end, a conveying means for transporting the food product through the tunnel from the inlet to the outlet; the housing including a first cooling unit that defines a first thermal zone configured to cool the food product to a first temperature and a second cooling unit that defines a second thermal zone downstream of the first thermal zone in a direction of movement of the food product through the tunnel configured to cool the food product to a second temperature lower than the first temperature; each cooling unit including (a) an air circulation system for circulating air within the thermal zone, and (b) a heat exchanger for cooling air within the thermal zone; wherein in use the circulating air and the food product within each thermal zone are in a heat exchange relationship whereby heat from the food product is transferred to the circulating air and the heat exchanger extracts heat from the circulating air and exhausts the heat from the thermal zone.

2. The cooling tunnel of claim 1, wherein the first and second thermal zones are thermally isolated from each other.

3. The cooling tunnel of claim 1, wherein the first and second thermal zones are selectively sealable to restrict or prevent altogether air flow between thermal zones.

4. The cooling tunnel of claim 1, further comprising one or more than one cooling units in addition to the first and second cooling units.

5. The cooling tunnel of claim 1, wherein the air circulation system includes a plurality of fans.

6. The cooling tunnel of claim 1, wherein each thermal zone includes at least two air chambers in fluid communication with each other.

7. The cooling tunnel of claim 6, wherein the air circulation system is configured to force air within each thermal zone to flow between the air chambers of the thermal zone.

8. The cooling tunnel of claim 1, wherein the air circulation system is configured so that air flow within each thermal zone is generally cyclonic.

9. The cooling tunnel of claim 6, wherein the air circulation system includes an air plenum to provide the fluid communication between the air chambers within each thermal zone.

10. The cooling tunnel of claim 1, wherein the air circulation system is configured so that air flow within each air chamber is generally vertical.

11. A method of cooling a food product in a cooling tunnel, the method including:
i. transporting the food product via a conveying means through an inlet of the cooling tunnel into a first thermal zone;
ii. supplying cooled air to the first thermal zone and thermally treating the food product within the first thermal zone for a time sufficient to lower the temperature of the food product from an initial temperature to a first temperature less than the initial temperature;
iii. transporting the food product via the conveying means from the first thermal zone into a second thermal zone;
iv. supplying cooled air to the second thermal zone and thermally treating the food product within the second thermal zone for a time sufficient to lower the temperature of the food product from the first temperature to a second temperature less than the first temperature; and
v. transporting the food product via the conveying means through an outlet of the cooling tunnel.

12. The method of cooling a food product in a cooling tunnel of claim 11, wherein thermally treating the food product includes exposing the food product to a forced air flow such that heat is transferred from the food product to air within the thermal zone.

13. The method of cooling a food product in a cooling tunnel of claim 12, wherein a heat exchanger transfers heat from the air within the thermal zone to ambient air outside of the tunnel.

14. The method of cooling a food product in a cooling tunnel of claim 11, wherein the conveying means is configured to periodically automatically advance the food product sequentially between the thermal zones.

15. The method of cooling a food product in a cooling tunnel of claim 11, wherein a further step of pre-cooling the food product from an ambient temperature to the initial temperature precedes step (i).

16. The method of cooling a food product in a cooling tunnel of claim 11, wherein a further step of cooling the food product from the second temperature to a lower final temperature follows step (v).
